(19) United States
(12) Patent Application Publication
(10) Pub. No.: US 2006/0077118 A1
(43) Pub. Date: Apr. 13, 2006

(54) Foldable widescreen display

(75) Inventors: Jih Fon Huang, Zhubei City (TW); Ming-Daw Chen, Hsinchu City (TW); Chang Ho Liou, Shetou Shiang (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/995,486

(22) Filed: Nov. 24, 2004

(30) Foreign Application Priority Data
Oct. 8, 2004 (TW) 93130474

(51) Int. Cl. G09G 5/00; G06F 1/16

(52) U.S. Cl. 345/1.3; 361/681

(57) ABSTRACT

The present invention provides a foldable widescreen display, comprising: a main body having an input device arranged therein for converting an input data into an electrical data; and a display panel, electrically connected to the main body for displaying the electrical data by a specific video format; wherein the display panel is made of a material selected from the group consisting of a metal foil or plastic, that is capable of being bended into the specific shape by exerting an external force thereon.

### 1. FIELD OF THE INVENTION:

The present invention relates to a display, and more particularly, to a foldable widescreen display and a method of folding the same.

### 2. BACKGROUND OF THE INVENTION:

Nowadays, flat panel displays are widely used in various products such as computers, mobile phones, TVs, digital cameras, digital video cameras, watches, personal stereos, car/motorcycle instrument panels, signboards, and so on. However, most of such flat panel displays employ rigid display panel, that the rigidity of the display panel greatly limits the application of such display.

To overcome the abovementioned limitation, several related patents had been published. Please refer to FIG. 1A, which is a schematic illustration showing a liquid crystal display device disclosed in U.S. Pat. No. 6,016,176 of Kim, et al., entitled “Liquid Crystal Display Device With A Flexible Liquid Crystal Cell That Is Folded”. The liquid crystal display device 1 of FIG. 1A comprises: a main body 12, having a X keyboard 121 arranged therein; and an LCD device 13, pivotally coupled to the main body 12 at the rear periphery of the upper surface of the main body 12 by a pivot axis 131 disposed at a side of the LCD device 13, wherein the LCD device 13 is capable of folding around the rounded front side of the main body 12 using the pivot axis 131 as rotary center while the flexible portion of the LCD device 13 is bent with the roundness of the rounded front side of the main body 12, as shown in FIG. 1B.

Another relating patent can be seen in FIG. 2A, which is a schematic illustration showing a mobile radio apparatus disclosed in U.S. Pat. No. 6,327,482 of T. Miyashita, entitled “Mobile Radio Apparatus With Auxiliary Display Screen”. The mobile radio apparatus 2 of FIG. 2A having a main display 21 and a plurality of input keys 22 installed therein has a connector 23 arranged at a side thereof. In addition, the mobile radio apparatus 2 has an auxiliary display 24 as accessory, which has a terminal potion 25 arranged on one side of the auxiliary display 24 and connectable to the connector 23. When the terminal portion 25 is inserted into the connector 23, the auxiliary display 24 is electrically connected to the apparatus 2 and capable of displaying data in the same manner as and at the same time as the main display 21 of the mobile radio apparatus 2, as shown in FIG. 2B.

Yet, another relating patent can be seen in FIG. 3A, which is a schematic illustration showing a foldable display disclosed in U.S. Pat. No. 6,577,496 of Gioscia et al., entitled “Non-Rigid Mounting Of A Foldable Display”. As seen in FIG. 3A and FIG. 3B, a double hinge mechanism 31 is used to couple the two sides 32a, 32b of the non-rigid support structure 3. The double hinge mechanism is used to hold a flexible display device 33 in the unfolded position. The flexible display device 33 is a single screen mechanism that has no seams or creases and is dual sided. An attachment mechanism is used to couple the flexible display to the hinge mechanism 311 along a center line axis extending the full length of the display device and dividing the display device into two equal area rectangles. The two edges of the flexible display device 33 furthest from and parallel to the center line axis are held in place by two slots 321a, 321b in the non-rigid support structure 3. The flexible display device 33 is free to move within the two slots such that the viewable area of the display device is held in a flat plane in both the folded and the unfolded positions. In this unfolded position, the entire viewable area of one side of the flexible display screen is now available as seen in FIG. 3B.

Further, another relating patent can be seen in FIG. 4A, which is a schematic illustration showing a multiple display device disclosed in U.S. Pat. No. 6,643,124 of P. J. Wilk, entitled “Multiple Display Portable Computing Devices”. The portable computing device 4 comprises: four functional panels, 41, 42, 43, 44, and four wing panels, 411, 412, 421, 422, wherein outer functional panels 42, 43, in a folded configuration, are joined by a major hinge (not shown), while panels 43, 44 and 41,42 are joined at edges opposing the major hinge by two minor hinges respectively; and wing panels 411, 412, 421, 422, including integral flat displays (not separately designated) are slidingly deployed from sides of functional panels 41, 42 such that the completely deployed device of FIG. 4A reveals either six or seven useable display screens, depending on whether functional panel 44 constitutes a display or output panel, or else an extension of input panel or keyboard. In FIG. 4B, a partially folded or deployed configuration of the computing device 4 of FIG. 4A is shown. Panels 41, 44 are opened out about the two minor hinges respectively, to reveal inside surfaces of functional panels 41-44 comprising display screens and input pad or keyboard. In FIG. 4C, a further stage of the folding of the computing device 4 of FIG. 4B is depicted. Panels 42, 43 are folded apart at approximately a right angle about the major hinge. Finally, as seen in FIG. 4D, the computing device 4 in a folded configuration is shown.

Although the foregoing patents all relate to the folding of a display with large displaying area, however, non of which is capable of folding the portion of the flexible and foldable panel not attached to the main body of the display into a specific shape (e.g. in two-ply style, in three-ply style, or in wrapping style), while a display panel of the foldable widescreen display is attached/connected to the main body thereof by only a portion.

### SUMMARY OF THE INVENTION

It is the primary object of the invention to provide a foldable widescreen display having a flexible and foldable display panel, by which the widescreen display of the invention can be compact and portable.

It is another object of the invention to provide a method of folding a foldable widescreen display, by which the display panel of the widescreen display is bended into a specific shape enabling the widescreen display of the invention to be compact and portable.

To achieve the above objects, the present invention provides a foldable widescreen display, comprising: a main body having an input device arranged therein for converting an input data into an electrical data; and a display panel, electrically connected to the main body for displaying the electrical data by a specific video format; wherein the display panel is made of a material selected from the group consisting of a metal foil or plastic, that is capable of being bended into the specific shape by exerting an external force thereon.

Further, the present invention also provides a method of folding a foldable widescreen display, comprising the steps of:
(a) providing a foldable widescreen display, comprising: a main body having an input device arranged therein for converting an input data into an electrical data; and a display panel, electrically connected to the main body for displaying the electrical data by a specific video format; wherein the display panel is made of a material selected from the group consisting of a metal foil or plastic; and
(b) exerting an external force on the display panel for bending the same into a specific shape.

Other objects, advantages and novel features of the present invention will become apparent upon study of the remaining portions of the specification and drawings.

### BRIEF DESCRIPTION OF THE DRAWINGS

FIG. 1A is a schematic illustration showing the deploying configuration of a liquid crystal display device disclosed in U.S. Pat. No. 6,016,176 of Kim, et al., entitled “Liquid Crystal Display Device With A Flexible Liquid Crystal Cell That Is Folded”.

FIG. 1B is a schematic illustration showing the folded configuration of FIG. 1A.

FIG. 2A is a schematic illustration showing a mobile radio apparatus disclosed in U.S. Pat. No. 6,327,482 of T. Miyashita, entitled “Mobile Radio Apparatus With Auxiliary Display Screen”.

FIG. 2B is a schematic illustration showing a cooperative displaying operation of the main display and the auxiliary display of FIG. 2A.

FIG. 3A is a schematic illustration showing a folded rigid support structure of a foldable display disclosed in U.S. Pat. No. 6,577,496 of Gioscia et al., entitled “Non-Rigid Mounting Of A Foldable Display”.

FIG. 3B FIG. 3A is a schematic illustration showing a depolying rigid support structure of FIG. 3A.

FIG. 4A is a schematic illustration showing the fully deploying configuration of a multiple display device disclosed in U.S. Pat. No. 6,643,124 of P. J. Wilk, entitled “Multiple Display Portable Computing Devices”.

FIG. 4B is an illustration showing a partially folded or deployed configuration of the computing device 4 of FIG. 4A

FIG. 4C is an illustration showing a further stage of the folding of the computing device 4 of FIG. 4B

FIG. 4D is an illustration showing the computing device of FIG. 4A in a folded configuration.

FIG. 5A is a representation showing a foldable widescreen display being applied to a foldable mobile phone according to a preferred embodiment of the present invention.

FIG. 5B is a representation showing a foldable widescreen display being applied to a foldable mobile phone while the mobile phone is in folded status according to a preferred embodiment of the present invention.

FIG. 5C is a representation showing a foldable widescreen display being applied to a foldable mobile phone while both the mobile phone and the display panel are in folded status according to a preferred embodiment of the present invention.

FIG. 5D is a side view of FIG. 5C.

FIG. 5E is a top view of FIG. 5C.

FIG. 6A is a representation showing a foldable widescreen display being applied to a portable computer according to a preferred embodiment of the present invention.

FIG. 6B is a top view of FIG. 6A.

FIG. 6C is a representation showing a foldable widescreen display being applied to a portable computer while the display panel is in a folded status according to a preferred embodiment of the present invention.

FIG. 6D is a representation showing a foldable widescreen display being applied to a portable computer while the display panel is in a folded status according to another preferred embodiment of the present invention.

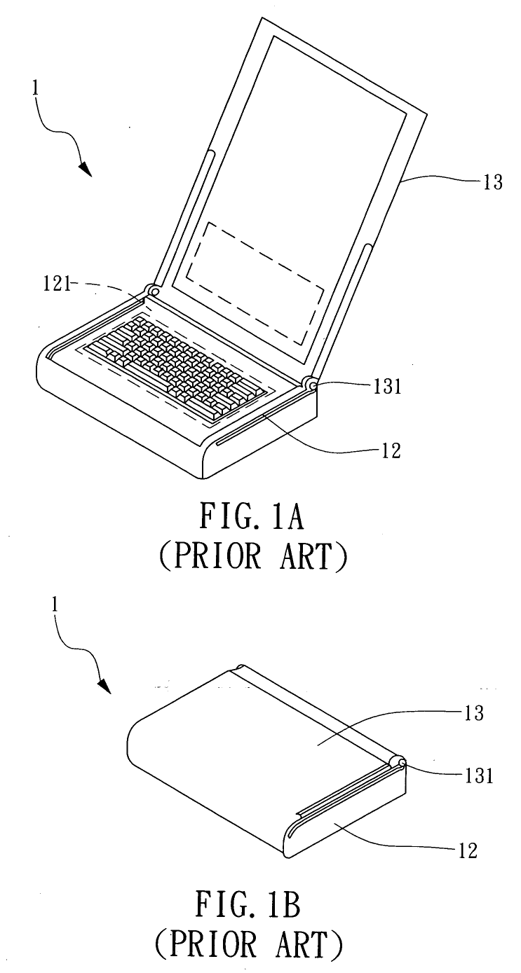

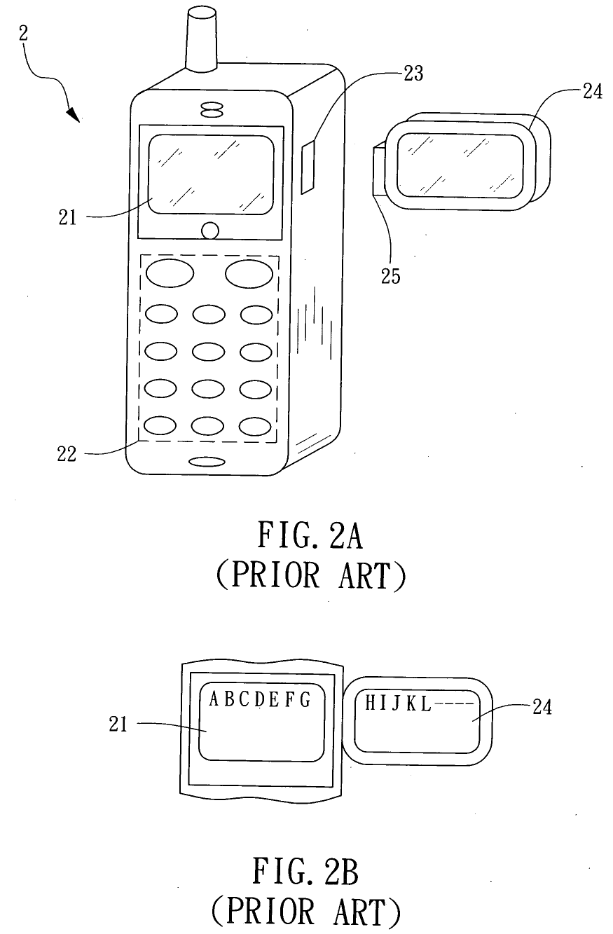

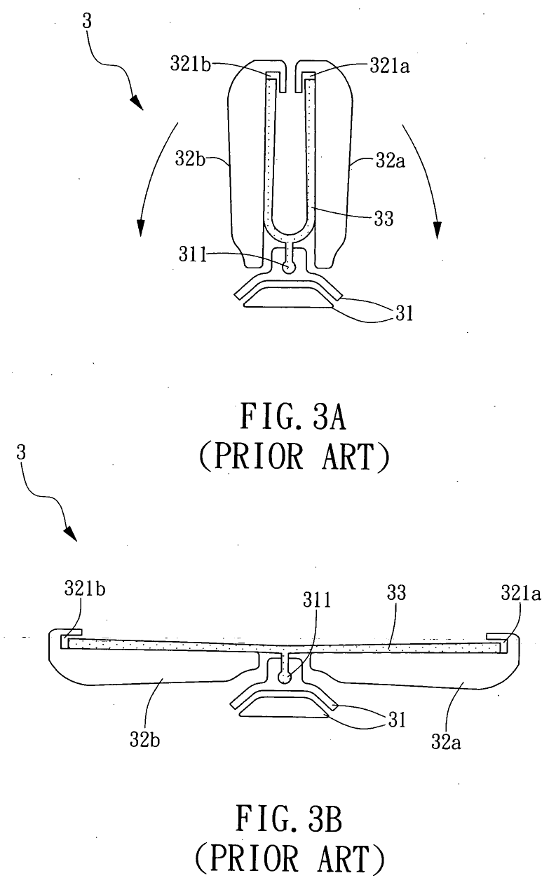

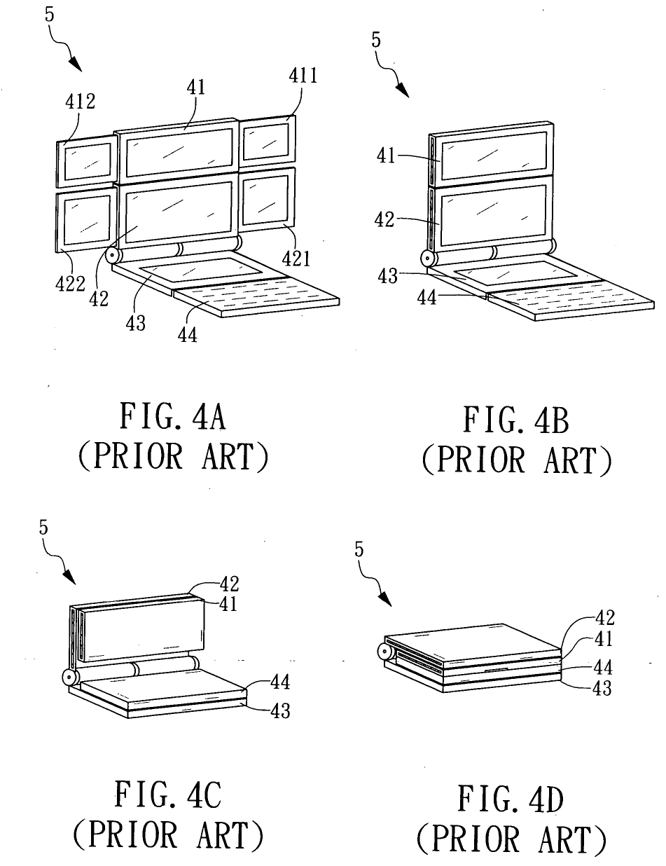

### DESCRIPTION OF THE PREFERRED EMBODIMENT

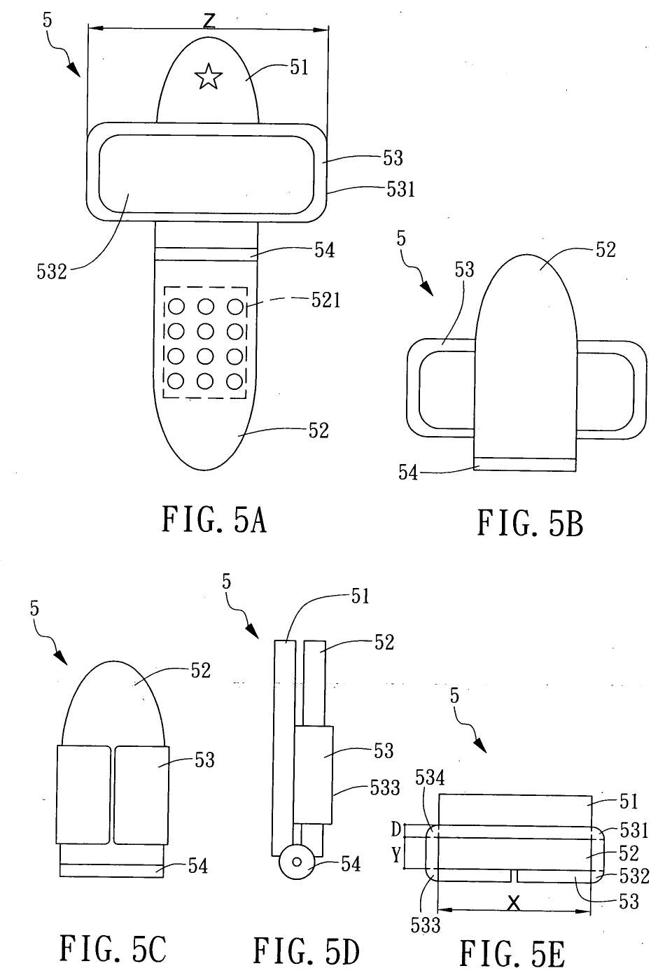

Please refer to FIG. 5A-FIG. 5C, which are representations showing a foldable widescreen display being applied to a foldable mobile phone according to a preferred embodiment of the present invention. The mobile phone 5 of this embodiment comprises: a top casing 51, having a keyboard arranged therein; a bottom casing 52; a foldable widescreen display panel 53, being attached to the top casing 51 and electrically connected to the circuits arranged in the top casing 51 and the bottom casing 52 in respective; and a pivot axis 54, wherein the top casing 51 is pivotally joined to the bottom casing 52 by the pivot axis 54; and the keyboard 521 is capable of converting an data inputted by a user into an electrical data for showing the converted electrical data on the foldable widescreen display panel 53 in a specific video format. In addition, the foldable widescreen display panel 53 of length Z further comprises a side 531, a display surface 532 and a back surface 533.

As seen in FIG. 5B, the bottom casing 52 is rotated upwardly using the pivot axis as center for attaching the same onto the top casing 51. Therefore, the bottom casing 52 is being attaching to the foldable widescreen display panel 53, such that the mobile phone 5 is in so-called folded status.

Moreover, as seen in FIG. 5C, the foldable widescreen display panel 53 is bended for enabling the display surface 532 to wrap around the bottom casing 52 from both sides thereof, such that the overall shape of the mobile phone is compact and easy to carry.

As seen in FIG. 5D and FIG. 5E, for the bottom casing 52 having a width of X and a thickness of Y, and the foldable widescreen display panel 53 having a thickness of D and in order to achieve a the wrapping status that the bended portion of the foldable widescreen display panel 53 is tightly wrapped on the bottom casing 52 and is not overlapping while the foldable widescreen display panel 53 is made of a preferred flexible material, the length Z of the foldable widescreen display panel 53 is larger than X, and is smaller than or equal to 2·X+2·Y+2·π·D, that is,
X<Z≦2·X+2·Y+2·π·D
where π represents ratio of the circumference of a circle to its diameter; and
   2·π·D represents the summation of circumferences 531, 532, 533 and 534.

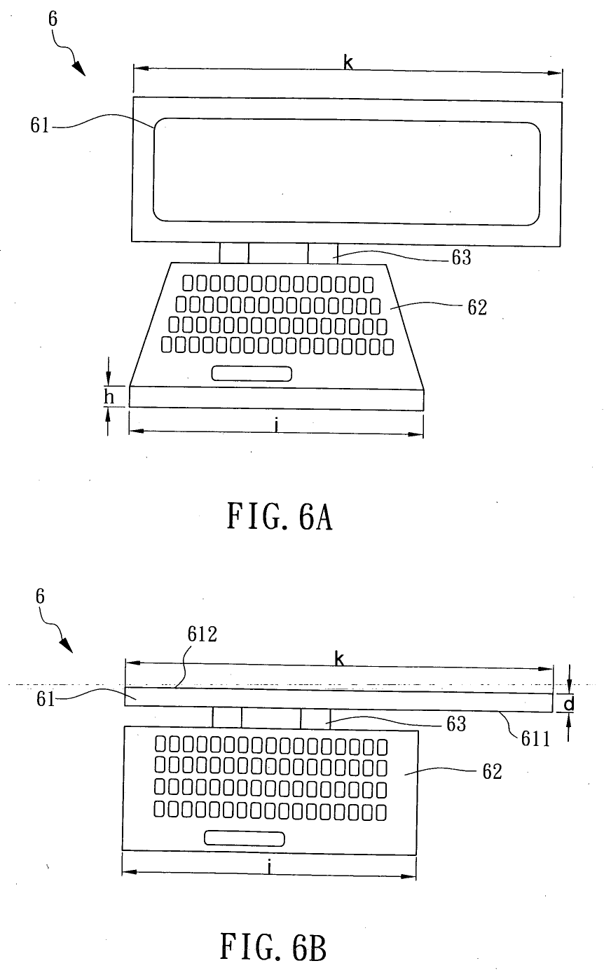

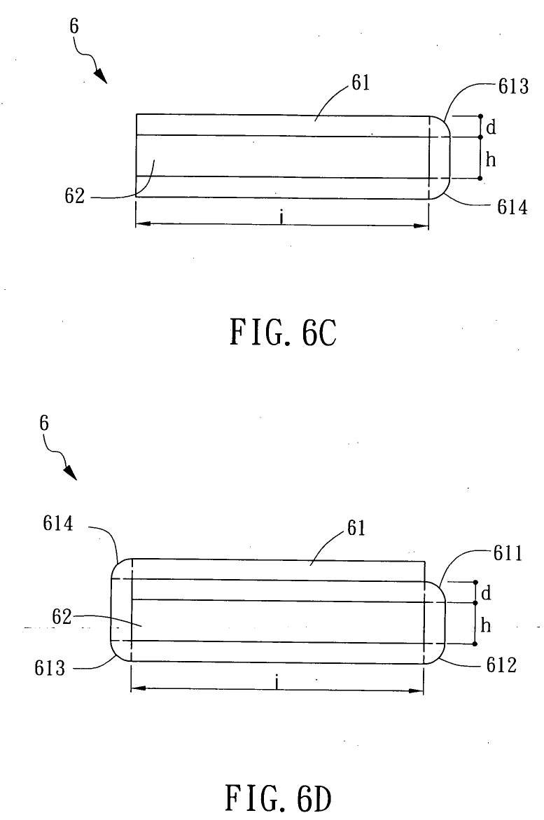

Please refer to FIG. 6A and FIG. 6B, which are representations showing a foldable widescreen display being applied to a portable computer according to a-preferred embodiment of the present invention. The portable computer 6 of FIG. 6A comprises: a foldable widescreen display 61 of k length; and a main body 62, jointed to the foldable widescreen display 61 by a pivot axis 63, wherein the foldable widescreen display 61 is capable of being bended into any shape at will and rotating about the pivot axis 63 for attaching the same onto the main body 62. In addition, the foldable widescreen display 61 further comprises a display surface 611 and a back surface 612 opposite to the display surface 611.

Please refer to FIG. 6C, which is a representation showing a foldable widescreen display being applied to a portable computer while the display panel is in a folded status according to a preferred embodiment of the present invention. As seen in FIG. 6C, the foldable widescreen display 61 is attached to the main body 62, and more particularly, the foldable widescreen display 61 is also being bended and wrapped around the main body 62. For the main body 62 having a width of i and a thickness of h, and the foldable widescreen display panel 61 having a thickness of 4 and in order to achieve a the wrapping status that the bended portion of the foldable widescreen display panel 61 is tightly wrapped on the main body 62, the length k of the foldable widescreen display panel 53 is at least larger than i, and is smaller than or equal to 2·i+h+π·d, that is,
i<k≦2·i+h+π·d
where π represents ratio of the circumference of a circle to its diameter; and
   π·d represents the summation of circumferences 613 and 614.

Please refer to FIG. 6D, which is a representation showing a foldable widescreen display being applied to a portable computer while the display panel is in a folded status according to another preferred embodiment of the present invention. As seen in FIG. 6D, the foldable widescreen display panel 61 is attached to the main body 62, and more particularly, not only the foldable widescreen display panel 61 is bended and tightly wrapped on the main body 62, but also a portion of the foldable widescreen display panel 61 is further bended twofold so that the display surface 611 is attached to the back surface 612. For the main body 62 having a width of i and a thickness of h, and the foldable widescreen display panel 61 having a thickness of d and in order to achieve a the wrapping status that the bended portion of the foldable widescreen display panel 61 is tightly wrapped on the main body 62, the length k of the foldable widescreen display panel 53 is at least larger than 2·i+2·h+2·π·d+d, and is smaller than or equal to 3·i+2·h+2·π·d+d, that is,

$$2 \cdot i + 2 \cdot h + 2 \cdot π \cdot d + d < k ≦ 3 \cdot i + 2 \cdot h + 2 \cdot π \cdot d + d$$

where π represents ratio of the circumference of a circle to its diameter; and
   2·π·d represents the summation of circumferences 611, 612, 613 and 614.

In a preferred embodiment, the foldable widescreen display is made of a material selected from the group consisting metal foil and plastic, where the metal foil can be iron or stainless steel, etc. Moreover, the foldable widescreen display can be made of any flexible material suitable to be used as flexible substrate of display panel. In addition, the above method of folding a foldable widescreen display mentioned in the foregoing embodiment, such as attaching the display surface with the back surface, attaching the display surface with another portion of the display surface, attaching the back surface with another portion of the back surface, attaching the display surface with the input device, attaching the back surface with the input device, should be considered in all respects as illustrative and not restrictive, the scope of the invention being indicated by the appended claims rather than by the foregoing description and all changes come with the meaning and range of equivalency of the claims are therefore intended to be embraced therein.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of folding a foldable widescreen display, comprising the steps of:
(a) providing a foldable widescreen display, comprising: a main body having an input device arranged therein for converting an input data into an electrical data; and a display panel, electrically connected to the main body; wherein the display panel is made of a flexible material; and
(b) exerting an external force on the display panel for bending the same into a specific shape.

2. The method as recited in claim 1, the method following the step (a) further comprising the step of:
(a1) outputting a specific video format with respect to the electrical data by the display panel; and
(a2) turning off the display panel.

3. The method as recited in claim 1, wherein the display panel has at least a side.

4. The method as recited in claim 3, wherein the side capable of being attached onto a display surface of the display panel.

5. The method as recited in claim 3, wherein the side capable of being attached onto a back surface of the display panel.

6. The method as recited in claim 1, wherein the display panel is a rectangle display panel with a first length, and the main body is a rectangle main body with a second length, and the first length is larger than the second length.

7. The method as recited in claim 1, wherein the largest linear distance measured between two points selected from the profile of the display panel is larger than the largest linear distance measured between two points selected from the profile of the main body.

8. The method as recited in claim 1, wherein the display panel has a display surface and a back surface opposite to the display surface, and the specific shape is substantially formed by bending the display panel for enabling the display surface to attach onto the back surface.

9. The method as recited in claim 1, wherein the display panel has a display surface and a back surface opposite to the display surface, and the specific shape is substantially formed by bending the display panel for enabling the display surface to attach onto the display surface.

10. The method as recited in claim 1, wherein the display panel has a display surface and a back surface opposite to the display surface, and the specific shape is substantially formed by bending the display panel for enabling the back surface to attach onto the back surface.

11. The method as recited in claim 1, wherein the display panel has a display surface and a back surface opposite to the display surface, and the specific shape is substantially formed by bending the display panel for enabling the display surface to attach onto the main body.

12. The method as recited in claim 1, wherein the display panel has a display surface and a back surface opposite to the display surface, and the specific shape is substantially formed by bending the display panel for enabling the back surface to attach onto the main body.

13. The method as recited in claim 1, wherein the display panel has a display surface and a back surface opposite to the display surface, and the specific shape is substantially formed by bending the display panel for enabling the display surface and the back surface to attach onto the main body in respective.

14. The method as recited in claim 1, wherein the flexible material is a material selected from the group consisting of metal foil and plastic.

15. A foldable widescreen display, comprising:
a main body, having an input device arranged therein for converting an input data into an electrical data; and
a display panel, electrically connected to the main body for displaying the electrical data by a specific video format;
wherein the display panel is made of a flexible material, capable of being bended into the specific shape by exerting an external force thereon.

16. The display as recited in claim 14, wherein the display panel has at least a side.

17. The method as recited in claim 15, wherein the side capable of being attached onto a display surface of the display panel.

18. The display as recited in claim 3, wherein the side capable of being attached onto a back surface of the display panel.

19. The display as recited in claim 14, wherein the display panel is a rectangle display panel with a first length, and the main body is a rectangle main body with a second length, and the first length is larger than the second length.

20. The display as recited in claim 14, wherein the display panel has a display surface and a back surface opposite to the display surface, and the specific shape is substantially formed by bending the display panel for enabling the display surface to attach onto the back surface.

21. The display as recited in claim 14, wherein the display panel has a display surface and a back surface opposite to the display surface, and the specific shape is substantially formed by bending the display panel for enabling the display surface to attach onto the display surface.

22. The display as recited in claim 1, wherein the display panel has a display surface and a back surface opposite to the display surface, and the specific shape is substantially formed by bending the display panel for enabling the back surface to attach onto the back surface.

23. The display as recited in claim 1, wherein the display panel has a display surface and a back surface opposite to the display surface, and the specific shape is substantially formed by bending the display panel for enabling the display surface to attach onto the main body.

24. The display as recited in claim 1, wherein the display panel has a display surface and a back surface opposite to the display surface, and the specific shape is substantially formed by bending the display panel for enabling the back surface to attach onto the main body.

25. The display as recited in claim 1, wherein the display panel has a display surface and a back surface opposite to the display surface, and the specific shape is substantially formed by bending the display panel for enabling the display surface and the back surface to attach onto the main body in respective.

26. The display as recited in claim 1, wherein the flexible material is a material selected from the group consisting of metal foil and plastic.
